(19) United States
(12) Patent Application Publication
(10) Pub. No.: US 2012/0003336 A1
(43) Pub. Date: Jan. 5, 2012

(54) Rodent and Insect Repellent System For Vehicles And Trailers Therefor

(76) Inventor: Jonathan P. Del Grande, Caledon (CA)

(21) Appl. No.: 12/830,368

(22) Filed: Jul. 5, 2010

(51) Int. Cl. A01N 65/22; A01P 11/00; A01P 17/00; A01N 35/04; A01N 65/00

(52) U.S. Cl. 424/747; 514/692; 424/770

(57) ABSTRACT

A rodent and insect repellent system that effectively deters or repels rodents, squirrels, small animals and crawling insects from entering vehicles such as cars, trucks, motor homes, trailers, tractors and recreational vehicles. The invention is a process in which an application of a non-drip oily coating is applied to the entire undercarriage and engine compartment of a vehicle. The coating prevents rodents, squirrels, small animals and crawling insects from traveling across areas coated. This coating stays we and slippery to the touch, yet it will not drip or dry out. In addition, the coating is scented with natural essential oils which overwhelm the acute sense of smell that rodents have and drive them away from the vehicle.

This invention provides an effective means of repelling rodents, small animals, and crawling insects from entering cars, trucks, tractors, motor homes, trailers and recreational vehicles by preventing entry through small holes within the undercarriage or underside of the structure.

### BACKGROUND OF THE INVENTION

Rodents are widely known for their ability to gain access to vehicles such as cars, trucks, tractors, motor homes, trailers and recreational vehicles by entering through small holes within the undercarriage. These holes are designed to accommodate hoses, pipes and wires that pass from the underside of the vehicle to the inside of the vehicle. Rodents have a natural instinct to nest. This nesting instinct causes them to chew and gnaw on many different materials. They will chew on wires, circuitry, hoses, and other components essential to the vehicle's operation. In many instances this will leave the vehicle completely disabled. Repair bills are often not covered under manufacturer warranties and some insurance companies deny claims due to rodent infestations. Rodents can carry disease. Hantavirus, a particularly dangerous disease carried by deer mice, can be breathed in while cleaning up mouse droppings. Hence, there is a need for a system that prevents entry of rodents into vehicles and other structures.

### DESCRIPTION OF THE PRIOR ART

Rodent repellent systems have been in use for many years. There are also many different approaches of repelling rodents or alternatively killing rodents that have been invented.

A commonly used repellent is mothballs. Mothballs are made from the chemical naphthalene, which emits an odour that drives mice away from the area where they have been placed, but do not prevent entry into the vehicle. Unfortunately, the chemical naphthalene is “known to the State of California to cause cancer”. In addition, mothballs do not prevent entry to the vehicle; they merely deter rodents once the odour becomes unbearable. The scent of mothballs is strong and has the negative effect of remaining in the unit making it unpleasant for humans.

Natural scent repellent inventions have become more popular with the rising concern over the use of mothballs. Although effective in the areas they are placed, they lose their effectiveness after about 30 to 90 days, requiring repeat applications. The scent repelling inventions do not prevent entry into the vehicle; rodents only leave after encountering the scent once they enter into the vehicle.

Poison is commonly used to kill rodents. However, poison also does not prevent entry to the unit and is considered inhumane. In addition, poison can be harmful or fatal to children and pets if touched or swallowed. Rodents often die within the vehicle, permeating the area with the smell of decaying carcasses. Poison does not prevent entry into the vehicle.

Traps come in many shapes and sizes. They can be very effective at catching a rodent that made it inside the vehicle but they do not prevent entry. Some types of traps are considered inhumane.

Ultrasonic devices claim to repel mice by using a frequency that rodents hear. The art works well for a few weeks until the rodent gets used to it, or the desire for food and shelter becomes stronger than the irritation from the sound emitted by the frequency from the ultrasonic device. They also require a constant power source, which on most vehicle applications is not readily available.

Typically rodent repellents of these types are shown, for example, in the following United States of America patents:

| | |
|---|---|
| 7,506,471 | Rodgers |
| 4,756,755 | Harding |
| 5,735,803 | Katz et al |
| 4,035,482 | Royster |
| 6,337,081 | Warberg |
| 7,274,650 | Jan |
| 6,990,767 | Zamir |
| 7,607,254 | Huang |

While these inventions may achieve the purpose for which they were intended, they are not suitable for preventing rodents from gaining entry into a vehicle, they merely address the problem once they have gained entry, either by repelling the rodent to leave the area or by killing the rodent.

In these respects, the rodent repellent system according to the present invention substantially departs from the conventional concepts and designs of the prior art, and in so doing provides a unique process of application in which the entire undercarriage of a vehicle is sprayed with a wet, oily non-drip gel coating that prevents rodents from travelling across, climbing on, chewing on, or nesting within the vehicle.

### SUMMARY OF THE INVENTION

Considered broadly, rodent repellent inventions have achieved limited success in repelling rodents in cars, trucks, tractors, motor homes, trailers and recreational vehicles.

The inherent disadvantage in the inventions in the prior art is that rodents gain entry into the vehicle before they come into contact with the prior art's repelling properties. Rodents quite often have already caused damage to the undercarriage wires and hoses before they work their way inside through the small holes on the underside of the vehicle.

In addition, rodents frequently nest in cavities in the undercarriage of the vehicle, damaging components on the exterior of the vehicle such as the air filter intake, wires and hoses. The prior arts, such as mothballs, poison, or traps are generally intended for the vehicle interior and are ineffective at preventing rodents from nesting in the undercarriage of the vehicle.

In view of the foregoing disadvantages in the known types of repellents in the prior art, the present invention provides a rodent and insect repellent system designed specifically for applications in which the floor or base or undercarriage of the vehicle or structure is suspended or floating in the air. The vehicle or structure may be held above the ground so as to be floating or suspended by the wheels and their supporting axles and body mounts such as is found on a motor home or a travel trailer, or the structure may be held above the ground by posts or concrete blocks under a semi-permanent structure such as a four season mobile home.

The general purpose of the present invention, which will be described subsequently in greater detail, is designed to prevent rodents and insects from entering vehicles from the ground up. The present rodent and insect repellent system has many advantages of the repelling systems mentioned heretofore, with a new invention in rodent repelling that results in a new rodent repellent system which is not anticipated, rendered obvious, suggested, or even implied by any of the prior arts. The inventive idea is a process and method of application to crucial areas of a vehicle or structure with a coating so as to prevent entry of rodents and insects. This process is complimented by the composition of the material. The material or make up thereof is oily, stays slippery and we to the touch for a full 12 months, and will not drip off the structure of the vehicle onto the ground. The composition of the invention is completely non-toxic and contains no poison or solvents. It is safe for use around pets and children, accidental contact with the material will not harm pets or children. Exposure to the material requires a need only to wash off the material with mild soap and warm water.

There has thus been outlined, the more important features of the invention in order that the detailed description thereof may be better understood, and in order that the present contribution to the art may be better appreciated. There are additional features of the invention that will be described hereinafter and that will form the subject matter of the claims appended hereto. In this respect, it is to be understood that the invention is not limited in its application to the specific details within the process and method or its composition. The invention is capable of other embodiments and of being practiced and carried out in many different ways. And it is to be understood that the phraseology and terminology used herein for the description should not be regarded as limiting.

### DRAWING DESCRIPTION

In the drawings, which form a part of this specification,

FIG. 1 is a side elevation view of a motor home;

FIG. 2 is a rear elevation view of a motor home;

FIG. 3 is a bottom view of the undercarriage of a motor home;

FIG. 4 is an enlarged side elevation view of the hoses and wires passing form the exterior of the undercarriage to the interior of a motor home.

### DETAILED DESCRIPTION OF THE INVENTION

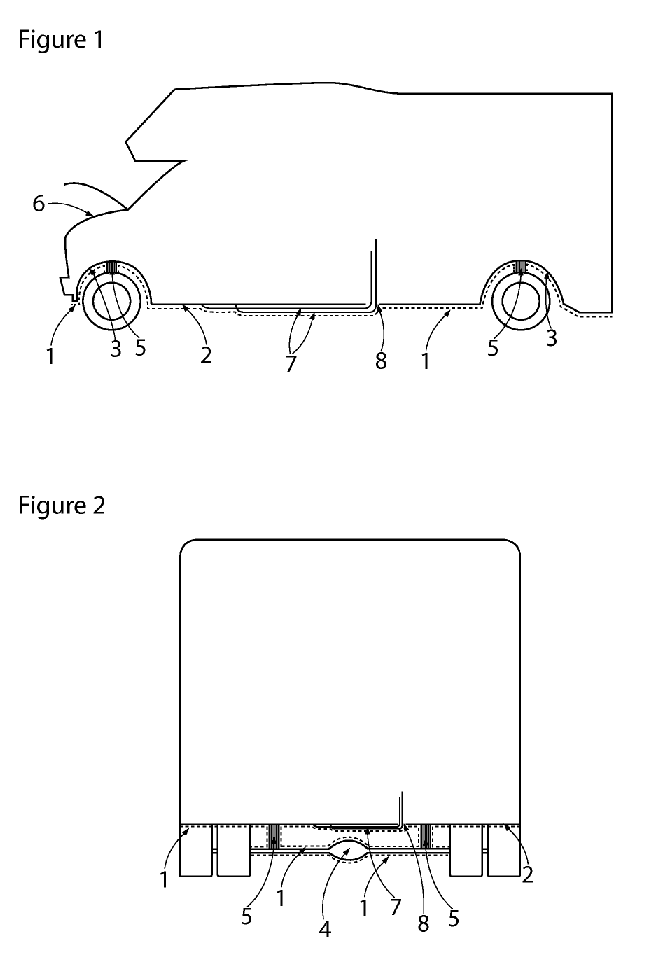

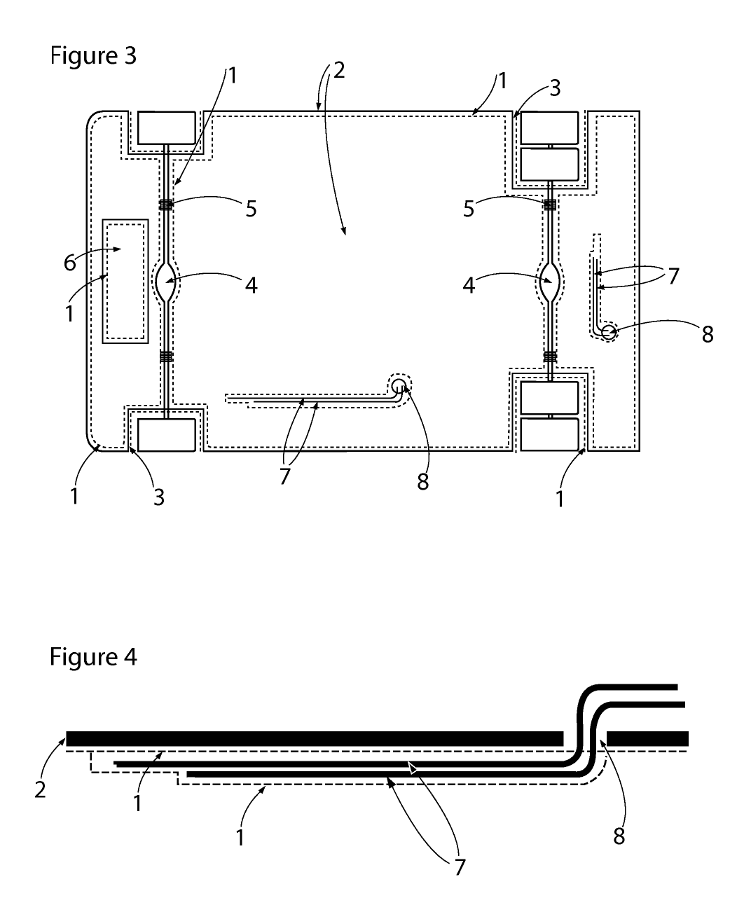

Within the drawings, the similar reference characters denote similar elements throughout FIGS. 1-4. In the particularly advantageous embodiment of the invention illustrated, take note that the coating 1 is applied to the undercarriage 2, the wheel wells 3, the axle 4, the body mounts 5, the engine compartment 6, wires, and hoses 7, and entry hole 8. The coating 1 eliminates a rodent's or insect's ability to travel or navigate across the undercarriage 2 by creating a surface that is excessively slippery to crawl over and creating an undesirable area to nest in or otherwise approach to go near the coating 1.

The application of the coating 1 to all components 2, 3, 4, 5, 6, and 7 ensures complete effectiveness of the invention to repel rodents and crawling insects.

A thorough and complete coverage with the coating is necessary to the axle 4, for this is the first location rodents or insects come into contact with as they climb up the tires and attempt to make their way onto the undercarriage 2 in order to gain access to the entry hole 8. Further the coating must be applied to mounts 5. Further the coating must be applied to the entire undercarriage 2. Further the coating must be applied to the wheel wells 3. Further the coating must be applied to the engine compartment 6, if the vehicle is equipped with one. Further the coating must be applied to the wires, hoses and pipes 7. Further the coating must be applied to the entry hole 8.

It must be emphasised, the invention works only when all components 2, 3, 4, 5, 6, 7, and 8 are coated with the rodent repelling invention. For if any of the 2, 3, 4, 5, 6, 7, and 8 are left uncoated and unprotected it may allow a rodent or insect to find their way onto the untreated area allowing possible damage to occur.

The coating 1 can be applied with any method application desired, such as rolled, brushed or sprayed. Although, a high pressure paint spray system will achieve the quickest and most desirable results. Ensure the coating 1 is applied with a minimum of 2 mm thickness. This ensures the coating 1 will prevent the ability of the rodent or insect to travel across the coating 1.

The composition of the coating 1 has a base of non-drip petroleum oil with a viscosity of 220. The base oil of the coating 1 makes up 99% by volume the complete composition. The remaining 1% by volume is completed with oil of peppermint 0.25%, oil of spearmint 0.25%, oil of camphor 0.1%, oil of cedarwood 0.2%, oil of lavender 0.2%. Blending of these essential oils can be achieved with a low speed mixer at ambient temperature.

It must be noted that the effectiveness of the invention lies in the fact that the coating 1, is comprised of oil that stays we to the touch, for it is the slippery element of the oil that prevents rodents and insects from gaining access to the undercarriage 2 and further gaining access to the interior of the vehicle via the entry hole 8. Essential oils of peppermint, spearmint, camphor, cedarwood, and lavender are added to scent the base non-drip oil. This increases the repellent properties of the base non-drip oil by overwhelming the very acute sense of smell that rodents have, repelling them away from the coating 1. Additionally, the essential oils create a pleasant scent for the person applying the coating 1.

In addition, the invention of a process or method of application to components 2, 3, 4, 5, 6, 7, and 8 is one major aspect as to where the invention distinctly sets itself apart as different from all prior arts.

It will be apparent that various changes and modifications can be made without departing from the scope of the invention as defined in the claims. With respect to the above description, it is to be realized that variations in composition of coating materials will perform a similar rodent and insect repellent capability, and are deemed readily apparent and obvious to one skilled in the art, and all equivalent relationships to those illustrated in the drawings and described in the specification are intended to be encompassed by the present invention.

Therefore, the foregoing is to be accepted as illustrative only of the principles of the invention. Expanding further, since changes and modifications to the composition will provide a similar repelling result, it is not desired to limit the invention to the exact components or coating described herein. Further, since the process of applying the coating will achieve desired results on many different vehicles or alternately to other suspended or floating structures, it is not desired to limit the invention to the exact vehicles or structures mentioned. All suitable applications and equivalents will fall within the scope of the invention.

Having described the process and method of application as well as the composition of the coating within this invention, the invention is now claimed, as follows.

The embodiments of the invention in which an exclusive property or privilege is claimed are defined as follows:

1. A rodent and insect repellent system comprising of a process or method of applying a coating to repel and prevent entry of rodents, squirrels, small animals and crawling insects from entering vehicles such as cars, trucks, motor homes, trailers, tractors and recreational vehicles.

2. A process or method of claim 1 is a coating applied to either a portion or the complete area of an undercarriage of a vehicle such as cars, trucks, motor homes, trailers, tractors and recreational vehicles.

3. A process or method of claim 1 is a coating applied to the base of a structure that is suspended above the ground so as to prevent entry.

4. A process or method of claim 1 is a coating applied to the perimeter area of a structure so as to prevent entry.

5. A coating of claim 1 that remains we to the touch maintaining a slippery element and the base material is non-drip oil.

6. A coating of claim 5 that is applied to the undercarriage of a vehicle such as cars, trucks, motor homes, trailers, tractors and recreational vehicles.

7. A coating of claim 5 applied on wires, hoses, pipes and items to prevent damaged by rodents.

8. A coating of claim 5 applied in the engine compartment to prevent rodents and insects from gaining entry to the engine components.

9. A coating of claim 1 that is scented with essential oils of peppermint, spearmint, camphor, cedarwood, and lavender.
